(19) United States
(12) Patent Application Publication
(10) Pub. No.: US 2026/0017664 A1
(43) Pub. Date: Jan. 15, 2026

(54) SYSTEMS AND METHODS TO PRIORITIZE AGENT INBOX USING TRAFFIC SIGNAL PATTERN FOR DIGITAL CHANNELS

(71) Applicant: NICE LTD., Ra'anana (IL)

(72) Inventors: Kalleshwar KALSHETTY, Pune (IN); Nida Saher MUJAWAR, Solapur (IN); Subhash PORJE, Pune (IN); Kamalesh PATTANAIK, Pune (IN)

(21) Appl. No.: 18/767,698

(22) Filed: Jul. 9, 2024

(51) Int. Cl. G06Q 30/01

(52) U.S. Cl. CPC G06Q 30/01

(57) ABSTRACT

Interaction prioritization systems and methods, and non-transitory computer readable media, include receiving a transcript of a first customer interaction in an agent inbox; extracting, in real-time, keywords from the transcript; comparing, in real-time by an artificial intelligence (AI) model, the extracted keywords to keywords in a customized historical database; calculating, in real-time by the AI model, a priority score of the first customer interaction based on the comparison; assigning, in real-time by the AI model, a priority to the first customer interaction based on the calculated priority score; and applying, in real-time, a visual indicator on the first customer interaction in the agent inbox, wherein the visual indicator corresponds to the assigned priority of the first customer interaction.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for assessing priority of real-time customer interactions in an agent inbox, and more particularly to methods and systems that prioritize real-time customer interactions and apply a visual indicator on the customer interactions that correspond to an assigned priority.

### BACKGROUND

In contact centers today, it is difficult to analyze interactions in real-time to decide priority for interactions that are routed to an agent inbox. Agents currently search or read the entire contents manually to identify the urgency of an interaction, which leads to increased average contact handling time. In addition, this results in long waiting times in queues for customer queries that are critical and require priority attention. It is difficult for agents to process the real-time information provided on the message threads and interaction transcripts.

Accordingly, there is a need for a method to automatically identify high priority interactions and indicate that they should be handled before other interactions in an agent inbox.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of an interaction prioritization system according to embodiments of the present disclosure.

FIG. 2 is a screenshot of how a custom entity recognition model is created within AWS Comprehend according to embodiments of the present disclosure.

FIG. 3 illustrates a code that is used to match keywords or key phrases and calculate the priority score according to embodiments of the present disclosure.

FIG. 4 is a block diagram of a process for agent inbox prioritization of various interactions according to embodiments of the present disclosure.

FIG. 5 is a flowchart of a process for agent inbox prioritization according to embodiments of the present disclosure.

FIG. 6 is a flowchart of a method according to embodiments of the present disclosure.

FIGS. 7-9 illustrate example simulations of agent inbox prioritization according to embodiments of the present disclosure.

FIG. 10 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present disclosure provides a solution that accurately assesses the priority of real-time interaction data and provides a visual indicator in the inbox of a user, e.g., a contact center agent. Real-time interaction data includes keywords or key phrases and attributes of the interaction (additional information of the interaction) such as an interaction ID, a timestamp (time when the interaction occurred), customer name, and content of the interaction. The visual indicator is used inside the agent inbox to draw attention to new or important information. In some embodiments, the visual indicator is associated with high priority, medium priority, or low priority to indicate the current priority of the interaction, although any type of priority or ranking (e.g. numerical ranking) may be used. The agent inbox is a digital inbox that contains a list of interaction objects such as emails, chats, and other digital channels and a reference to a visual indicator.

Visual indicators are tools that make things stand out and draw attention to something important. Visual indicators help ensure that vital information does not go unnoticed and enables and even promotes more timely responses by an agent (or another user). Visual indicators can include icons, shapes, added text, typographical styling, animation, color variations, arrows, images, a larger graphical representation, a colored graphical representation, and/or hatching or use of patterns to catch the attention of the agent. Agents are more likely to notice and respond promptly to new or important information when visual indicators are used. The solution highlights that the high priority interactions must be handled before the lower priority interactions, and prioritizes the agent inbox in real-time. Although the present disclosure focuses on use of color as a visual indicator, it should be understood that any type of visual indicator can be used to indicate priority.

This prioritization drives the sorting order of interactions assigned to an agent, as well. Upon analysis of interactions through the artificial intelligence (AI) based solution, high priority interactions are first visually indicated as high priority and placed at the top of the agent inbox. This contributes to a positive agent experience by providing clear and intuitive cues about the priority of the interactions (e.g., high, medium, and low) of the inbox. Sorting using only a prioritization scheme based on certain criteria is not believed to provide the same immediate attention-grabbing effect as a visual indicator. The present disclosure highlights the priority of interactions by considering numerous factors or attributes of the interaction that are fed into the AI system including the nature of the messages, issue type, keywords used, and customer type.

The present disclosure introduces an automated solution focused on analyzing interactions that can enhance workflow, providing agents with real-time inbox prioritization and management. This automation significantly can advantageously reduce the time agents spend addressing priority issues and ensure certain priority issues can be addressed sooner to help increase customer satisfaction.

In various embodiments, an AI model is created using Amazon Web Service (AWS) Comprehend and natural language processing (NLP). In one or more embodiments, AWS Comprehend is used for key phrase extraction from customer interactions. In several embodiments, after extraction, matching, scoring, and inbox alerting are designed using NLP logic and event handling technologies, such as the Lambda function handler.

Advantageously, the present systems and methods provide a customizable solution based on various business needs of contact centers. The scoring and matching pattern of datasets can be configured and customized according to specific business needs. Upon discovery of new information or data, the present methods add more information to the parent dataset. The visual indicator, for example a colored matrix representation, in the agent inbox is one of the highlights of the present disclosure that provides better handling of critical customers (or issues) or premium high valued customers (or issues) based on priority.

In one or more embodiments, when a new interaction (e.g., between customer and agent) arrives, the new interaction is added to the end of the agent queue along with its associated attributes (e.g., one or more of a customer ID, a contact method, issue type, timestamp, and customer type). As interactions continue to enter the queue, the priority score is calculated based on various factors (e.g., one or more keywords or phrases and attributes of the interaction such as sentiment). In one or more embodiments, the priority score is based on a historical relevance score, a key phrase relevance score, and a context relevance score.

The historical relevance score is typically based on the historical relevance of key phrases from past interactions, and can be calculated based on the frequency and importance of key phrases from a customized historical database. For example, keywords in the customized historical database can be taken from businesses or provided by businesses along with associated values for the keywords. In some embodiments, categories associated with keywords or key phrases are provided by businesses. The variety of categories and their associated key values can be stored in the customized historical database.

The key phrase relevance score is generally based on the presence and relevance of key phrases in the current interaction, and can be calculated based on the frequency or importance of key phrases in the current interaction. For example, AWS Comprehend extracts keywords from the current interaction and provides scores based on the relevance and importance of the keywords in the text of the current interaction.

The context relevance score is usually based on the context or situation of the current interaction. The context of the current interaction can be based on the urgency of the issue, the sentiment of the message, or the identity of the customer (e.g., high-value customers, frequent customers, etc.). Their associated values can be provided by one or more businesses.

Instead of directly adding new interactions to the queue, a priority queue data structure is used, where interactions are automatically sorted based on their priority score so the highest priority interaction is always at the front of the queue along with a visual indicator. Accordingly, agents pull interactions from the top of the queue for processing. Since the highest priority interaction is always provided at the front (or top) of the queue, agents naturally tend to handle high priority interactions first if a proposed interaction is not deferred for some important, permitted reason.

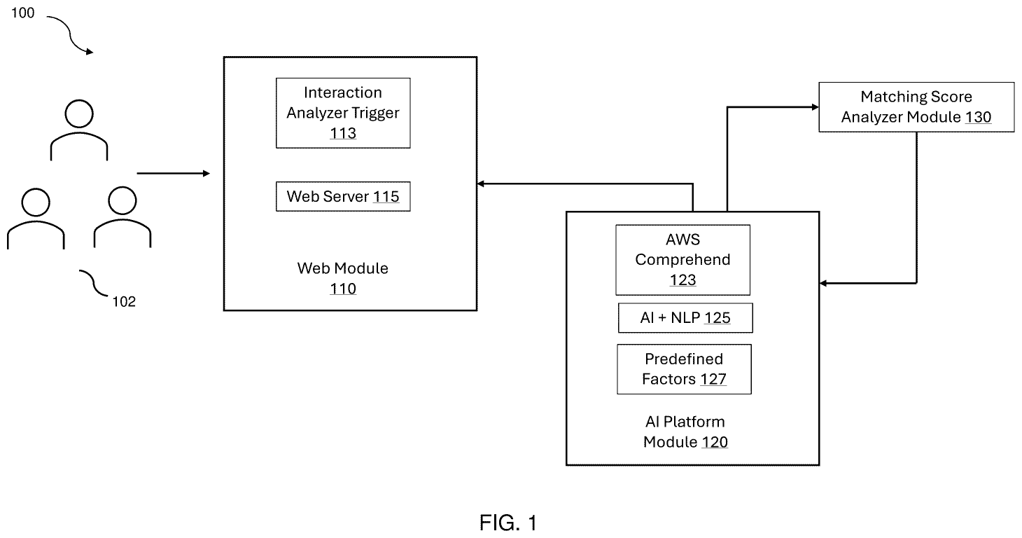

Referring to FIG. 1, shown is an interaction prioritization system 100 according to the present disclosure. The interaction prioritization system 100 includes web module 110, AI platform module 120, and matching score analyzer module 130.

Web module 110 is the main module that acts as a connecting link between the user interface (UI) where real-time interactions are coming in from customers 102 and the AI processing layer. Web module 110 is where analyzer trigger configurations are in place that send the data from the interactions to a back-end server where other modules can process the information. Upon detection of a result, the back-end modules send back the information and web module 110 captures them to show the visual indicator.

Web module 110 includes interaction analyzer trigger 113, which is a common web module design that is usually written for every web application that lets the back-end server know that on the web/UI side, a particular scenario is going on. It can be a simple WebSocket duplex connection stream that immediately opens a connection on an agent application on contact arrival. Interaction analyzer trigger 113 may be written on web-based codes by using JavaScript or Typescript on the front-end side of any application.

Web module 110 also includes web server 115, which is a server-side code module to which regular application program interfaces (APIs) or a WebSocket connection is sent from the front-end side. This web module 110 listens to request payload sent by the UI and then passes on the received request payload information to further back-end modules or units. Web server 115 can be written in any language like Java or Node.js based on the needs of any agent application. Web server 115 is the connection between the front-end and the AI layer. Getting the raw data from the front-end and returning the processed information back to the front-end after real-time analysis is a primary function of the web module 110.

AI platform module 120 is the main module where actual processing of information received from web module 110 takes place through a processing algorithm and AI. AI platform module 120 pieces together all the information and provides results to the next module that pushes the visual indicator to web module 110. With the number of factors and contact specific settings like desired matching score available on this module, when new information comes, it starts analyzing the data and calculates the priority score. Upon computation, it pushes the score to matching score analyzer module 130. Using the AWS service and NLP, new information is stored in a customized historical database (e.g. an extracted key phrase database), which keeps growing.

AI platform module 120 includes AWS Comprehend 123, which breaks down interaction text into smaller units, such as words or sub words known as tokens. Each token is tagged with its part of speech (e.g., noun, verb, adjective, etc.). AWS Comprehend 123 analyzes the syntax of the text to understand the relationship between words and phrases, and identifies named entities in the text such as people, organizations, locations and dates. Based on syntactic and sematic analysis, AWS Comprehend 123 identifies phrases likely to be considered important from the text. The extracted key phrases or keywords are scored and ranked based on their relevance and importance within the text. AWS Comprehend 123 provides the extracted key phrases or keywords and their scores to allow for analysis and interpretation of the results.

AI platform module 120 also includes AI+NLP 125. NLP techniques such as supervised learning algorithms can be used to classify incoming interactions or calls into different categories based on their nature or topic. The categories could include technical support, sales inquiries, billing issues, etc. The variety of categories with their associated key values could be stored in a historical database. In addition, AI+NLP 125 can analyze the sentiments expressed in the messages to gauge the emotional tone of the communication. Messages expressing frustration, anger, or urgency may be prioritized over neutral or positive messages.

AI platform module 120 also includes predefined factors 127. In one or more embodiments, premium high value customers may be listed with their weightage value. A variety of interaction types with contact arrival time and their weightage value can also be part of the predefined factors 127. For example, fraud: 1, need information: 0.25, service delivery information: 0.20, app crash: 0.45, and app slowness latency: 0.4 can be part of the predefined factors 127. In several embodiments, contact centers provide the metrics for which the interactions should be validated. For example, historical key phrases from past interactions may be another predefined factor.

Matching score analyzer module 130 receives the final output and whatever scores are generated with provided configurations after actual computation of the key phrase matching score. Matching score analyzer module 130 decides what kind of inbox prioritization is done on the inbox level based on the current prioritization categories. Matching score analyzer module 130 pushes final outputs on message stream to web module 110 for the visual indicators.

As part of the AI platform module 120, a customized historical database of customer interactions that can be used as training data to train a model is first provided. Below is an example of what the training data may look like:

TABLE 1
TRAINING DATA

| Customer | Contact | | | Customer | Priority |
|---|---|---|---|---|---|
| ID | Method | Customer Query from Contact | Issue Type | Type | Level |
| 001 | Email | I'm experiencing an issue | Technical Issue | Premium | High |
| | | when I try to log in to my | | | |
| | | account on the website. After | | | |
| | | entering my username and | | | |
| | | password, I click the login | | | |
| | | button, but nothing happens. | | | |
| 002 | Facebook | I have a question regarding | Billing Inquiry | Standard | Medium |
| | | my recent invoice for the | | | |
| | | services I've subscribed to. | | | |
| | | There seems to be a | | | |
| | | discrepancy in the amount | | | |
| | | charged compared to what I | | | |
| | | was expecting | | | |
| 003 | Chat | I'm facing difficulties | Product Support | Premium | Medium |
| | | downloading the annual | | | |
| | | reports from your website. | | | |
| | | Whenever I try to access | | | |
| | | them, the download process | | | |
| | | either doesn't start at all, or it | | | |
| | | gets stuck midway. | | | |
| 004 | WhatsApp | I'm a regular user of your | Technical Issue | Standard | Low |
| | | service and I'm interested in | | | |
| | | knowing when the new | | | |
| | | version will be available. | | | |

The training data is used to train a machine learning model to predict the priority level for new customer interactions based on keywords or key phrases and attributes of the interactions. Various machine learning models such as decision trees, random forests, or neural networks can be used to build the predictive model.

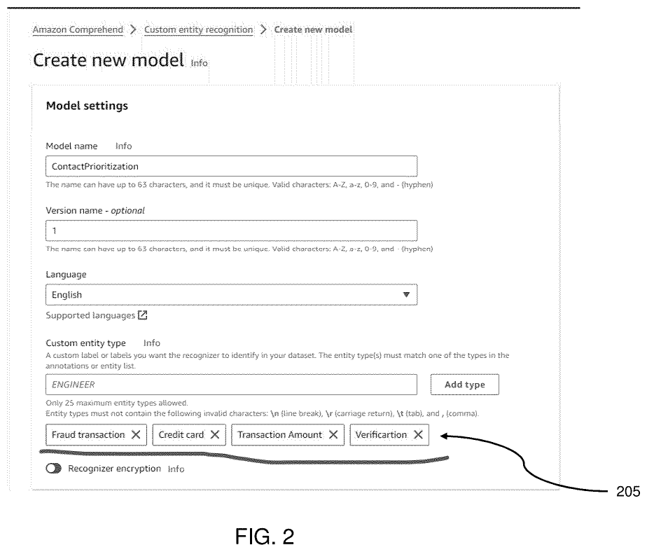

To build the model, in some embodiments, a custom entity recognition model within AWS Comprehend 113 is used to incorporate a custom entity type along with a training dataset as shown in FIG. 2. As can be seen, keywords 205 can be defined in a system like this. Such keywords can be custom-defined based on contact center type and business usage. Generally, a business of or associated with the contact center provides a set of the keywords for creation of the model, but a technical team can also provide this information. AI platform module 120 can continue adding similar words even after the model is initially developed to make the model more robust.

AWS Comprehend 123 trains the model using the specified keywords and training datasets (e.g., FIG. 1). Once a new interaction is received, AWS Comprehend 123 starts detecting the specified keywords in the new interaction and also starts extracting keywords from the new interaction. In an example, the extracted key words and phrases from the new interaction are “fraud transaction,” “my credit card account,” “back-to-back 3 transactions of $500 each,” and “without my OTP validation.”

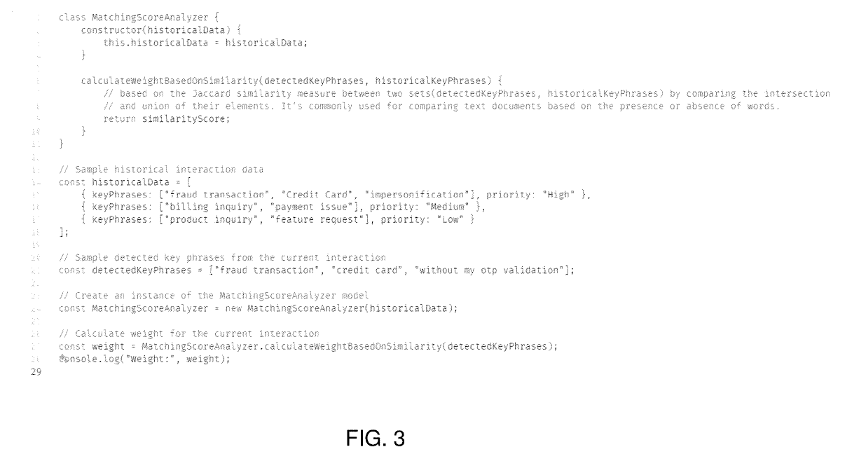

The detected keywords and the extracted keywords are then sent to matching score analyzer module 130 to calculate the priority score as shown in the code in FIG. 3. In several embodiments, matching score analyzer module 130 applies scoring logic using the Jaccard similarity concept. Jaccard similarity is a common proximity measurement used to compute the similarity between two objects, such as two text documents. Jaccard similarity can be used to find the similarity between two data sets. The more similar the data sets, the higher the percentage of similarity, and the more similar the data sets are.

The priority score is sent to web module 110 and based on the score, the agent inbox is organized so that the interaction with the highest priority score is placed at the top of the agent inbox with a visual indicator.

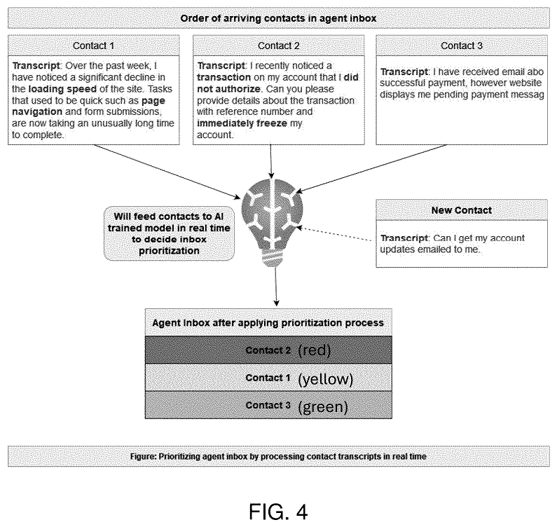

Referring now to FIG. 4, shown is a block diagram of a process for agent inbox prioritization. FIG. 4 highlights that keyword extraction from real-time interactions involves identifying important terms or phrases that are indicative of the content or context of the interaction. As shown, there are three interactions or contacts that arrive in the agent inbox with different contexts. AI platform module 120 analyzes the real-time interactions based on the predefined factors 127 (e.g., keywords and key phrases) configured for the business unit.

In a real-time interaction scenario, this process in FIG. 4 can be continuously applied to incoming interactions to dynamically extract and update keywords based on evolving content. It can be implemented using NLP techniques with real-time data processing systems. In this specific example, interaction or contact 2 has key phrases like “did not authorize” and “immediately freeze” so it is considered a high priority interaction (e.g., presuming fraud is prioritized as a high-priority issue) to be acted on by an agent in real-time at this moment. Therefore, in an exemplary embodiment, it is indicated with a red color visual indicator in the agent inbox. The other interactions are prioritized accordingly. For example, interaction or contact 1 is medium priority and is indicated with a yellow or amber color visual indicator, and interaction or contact 3 is low priority and is indicated with a green color visual indicator. While colored visual indicators are used in this example, other visual indicators (e.g., icons, enlarged text, animation, etc.) can be used alternatively or in addition to the colored visual indicator. Each interaction in the inbox has associated attributes including the priority score. The queue is a simple queue implementation using an array.

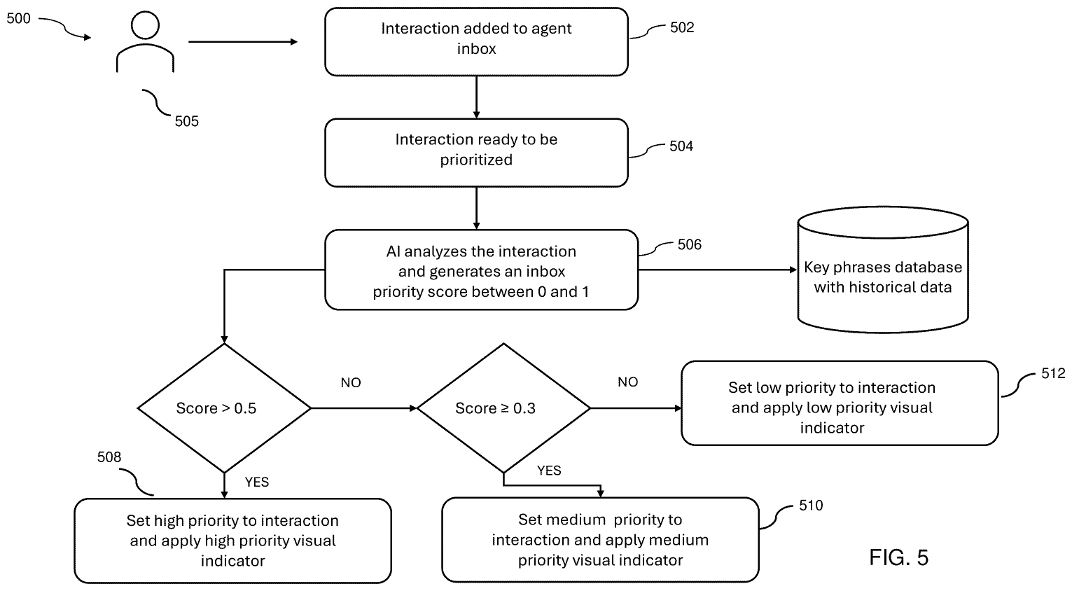

Turning now to FIG. 5, shown is an exemplary flowchart for inbox prioritization. As illustrated, various customers 505 initiate and reach out to the contact center with their respective queries, and a case for each respective digital channel is created. In several embodiments, the system 100 automatically starts assigning interactions to an agent inbox based on maximum contact handling bandwidth. At the same time, there could be multiple interactions from different customers that show up in a single agent inbox. Once the interaction is added to the agent inbox in step 502, the AI model analyzes the real-time interaction through the interaction analyzer trigger 113 in step 504. Extracted keywords from the real-time interaction are compared to keywords and/or key phrases in the customized historical database in step 506. In some embodiments, attributes of the real-time interaction are also compared to the data sets in the customized historical database. Also in step 506, the inbox priority score is calculated based on predefined factors (e.g., keywords and key phrases and attributes of the real-time interaction). Visual indicators are added to the interaction based on a priority score between 0 and 1.

If the priority score is greater than 0.5, the interaction is identified as high priority in step 508 and a red visual indicator is applied. If the priority score is between 0.3 and 0.5, the interaction is identified as medium priority in step 510 and an amber or yellow visual indicator is applied. If the priority score is less than 0.3, the interaction is identified as low priority in step 512 and a green visual indicator is applied. By recognizing these visual indicators in the inbox, agents can focus on appropriate interactions based on the priority and take required actions.

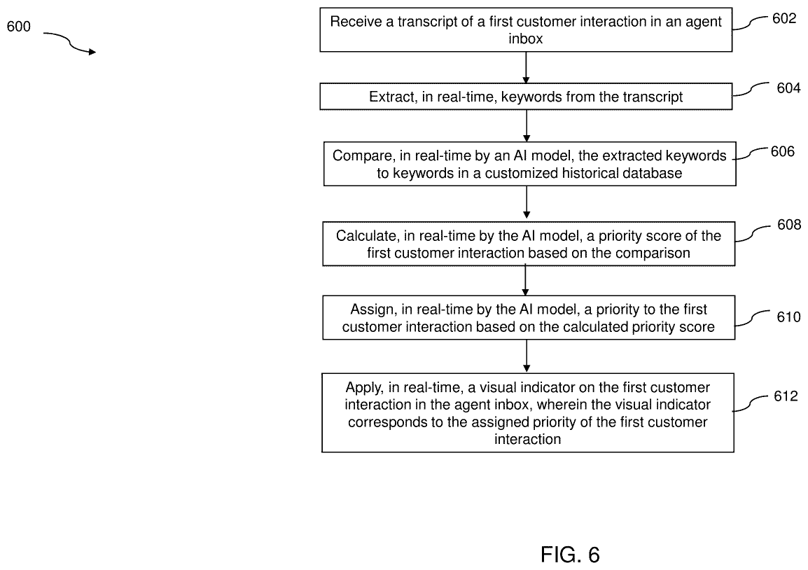

FIG. 6 shows an exemplary method 600 for prioritizing customer interactions according to the present disclosure. In step 602, web module 110 receives a transcript of a first customer interaction in an agent inbox. The first customer interaction can be any communication on any type of digital channel (e.g., email, chat, text, and social media).

In step 604, AWS Comprehend 123 extracts, in real-time, keywords from the transcript.

In step 606, the AI model compares, in real-time, the extracted keywords to keywords in a customized historical database. In several embodiments, the keywords in the customized historical database as categorized as low priority, medium priority, or high priority. In various embodiments, the customized historical database also includes historical attributes of interactions that are categorized as low priority, medium priority, or high priority. In several embodiments, the method 600 also includes comparing the attributes of the first customer interaction to the historical attributes in the customized historical database, and the priority score of the first customer interaction is also based on the comparison of the attributes to the historical attributes.

In step 608, the AI model calculates, in real-time, a priority score of the first customer interaction based on the comparison. In several embodiments, calculating the priority score includes determining a historical relevance score, a key phrase relevance score, and a context relevance score.

The historical relevance score is based on the historical relevance of key phrases from past interactions. The historical relevance score is calculated based on the frequency or importance of key phrases in the customized historical database.

The key phrase relevance score is based on the presence and relevance of key phrases in the first customer interaction. The key phrase relevance score is calculated based on the frequency or importance of key phrases in the first customer interaction.

The context relevance score is based on the context or situation of the first customer interaction. The context relevance score can be determined by factors such as the urgency of the issue, the sentiment of the interaction, or the identity of the customer (e.g., high-value customers).

In certain embodiments, each of the historical relevance score, key phrase relevance score, and context relevance score are normalized and the priority score is calculated based on a weighted combination of the normalized scores.

In one or more embodiments, determining the historical relevance score includes comparing the extracted keywords to the keywords in the customized historical database; determining the key phrase relevance score includes scoring the extracted keywords based on relevance and importance of the extracted keywords in the transcript; and determining the context relevance score includes extracting an urgency associated with the first customer interaction, a sentiment associated with the first customer interaction, a customer type of a customer associated with the first customer interaction, or a combination thereof.

In step 610, AI model assigns, in real-time, a priority to the first customer interaction based on the calculated priority score. In some embodiments, the assigned priority of the first customer interaction is low, medium, or high, and the visual indicator is colored based on the assigned priority.

In step 612, web module 110 applies, in real-time, a visual indicator on the first customer interaction in the agent inbox, wherein the visual indicator corresponds to the assigned priority of the first customer interaction. For example, a green visual indicator can be applied to a low priority customer interaction, a yellow visual indicator can be applied to a medium priority customer interaction, and a red visual indicator can be applied to a high priority customer interaction.

In certain embodiments, the method 600 also includes receiving a transcript of a second customer interaction in the agent inbox; extracting, in real-time, keywords from the transcript of the second customer interaction; comparing, in real-time, the extracted keywords from the transcript of the second customer interaction to the keywords in the customized historical database; calculating, in real-time, a priority score of the second customer interaction based on the comparison; assigning, in real-time, a priority to the second customer interaction based on the calculated priority score; applying, in real-time, the visual indicator on the second customer interaction in the agent inbox, wherein the visual indicator corresponds to the assigned priority of the second customer interaction; and sorting the first customer interaction and the second customer interaction in the agent inbox based on the assigned priority, wherein a customer interaction with a higher assigned priority is placed closer to a top of the agent inbox than a customer interaction with a lower assigned priority.

Table 2 below provides scenarios of a high priority interaction, a medium priority interaction, and a low priority interaction.

TABLE 2
PRIORITIES OF INTERACTIONS

| Priority | | |
|---|---|---|
| Score | Example | Outcome/Priority |
| Score >0.5 | 1. Customer has reported a | 1. The case gets higher |
| | fraud transaction on their | weight and is categorized as |
| | credit card and requested to | high priority by applying a |
| | block the credit card | red visual indicator. |
| | immediately. | 2. AI analyzes the interaction |
| | 2. High value customer | in real-time and compares the |
| | requested support and may | interaction with a set of rules |
| | not be impactful, but needs | that categorizes this |
| | attention. | interaction as high priority |
| | | and applies a red indicator. |
| Score ≥0.3 | Customer has reported | This case is important, but |
| | slowness in application, | does not require immediate |
| | which is impactful, but can | attention (and lower than the |
| | wait for resolution. | money fraud case) so it is |
| | | categorized by applying a |
| | | yellow visual indicator. |
| Score <0.3 | Customer has reported | This case is categorized as |
| | general query that is | low priority case by applying |
| | important, but may not | a green visual indicator. |
| | need immediate attention. | |

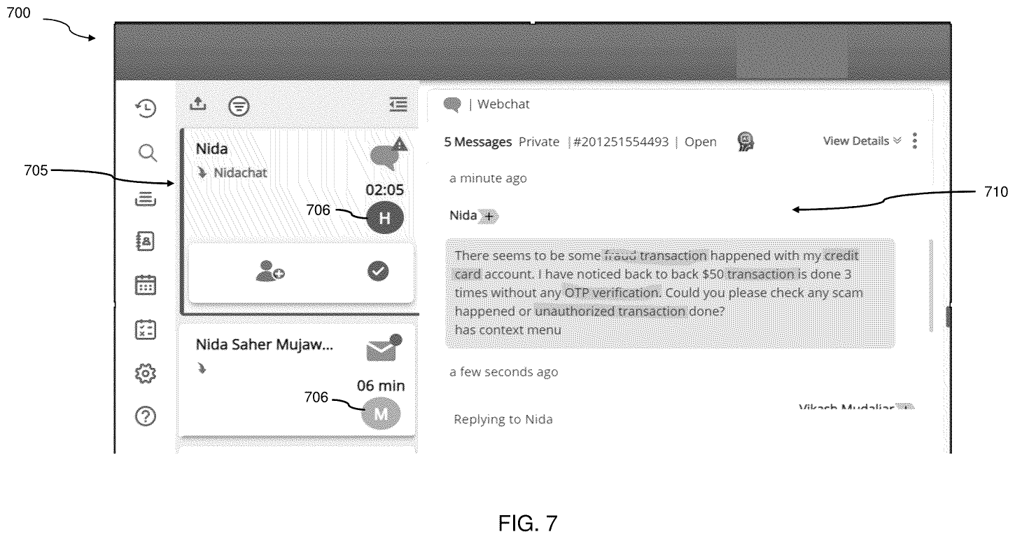

FIG. 7 illustrates a first example simulation 700, where the left side of the simulation 705 represents the inbox space or the interaction assignment space. The interaction assignment space shows the number of interactions present in the agent inbox with an applied visual indicator. The right side of the simulation 710 represents the interaction space. The interaction space shows the current messages coming in from the customer end on which the AI real-time analysis will run to calculate the priority score. The priority of each case is indicated by the circles 706.

Within the content of the message, the highlighted key phrases like fraud transaction, credit card account, OTP verification, and unauthorized transaction are extracted from the customer's message by using match logic against the customized historical database. To calculate the priority score, the following formula is generally used:

$$Priority score ( PS ) = 1 - ( normalized historical relevance score ( H ) + normalized key phrase relevance score ( EKP ) + normalized context relevance score ( C ) / 100 )$$

This formula allows for flexibility in adjusting the thresholds and weighting factors to reflect the priorities of various business units of the customers. In other embodiments, the thresholds for applying a particular priority may alternatively be, e.g., pre-defined by a user (such as an agent or a supervisor) or automatically determined so as to split a set of interactions into three similar-size estimated workflows, e.g., where ⅓ of the estimated workload falls into each of three prioritizations for a set of workflows. This threshold setting can be used to provide a prioritization for an agent's shift, across multiple agents for a period of time, etc.

The historical relevance score is based on key phrases like fraud transaction and credit card that is retrieved from the customized historical database. The key phrase relevance score is based on the key phrases like fraud transaction and credit card from the message. The context relevance score is based on the type of customer such as a premium/high-value customer.

With the current example, the below values for the above scores are provided:

$$H = 20 , EKP = 15 , C = 10$$

$$PS = 1 - ( 20 + 15 + 10 / 100 ) = 0.55$$

This interaction is flagged as high priority by applying a red visual indicator due to the keywords of these messages falling into a category of an interaction that requires high attention for a contact center agent. Such customers cannot or should not wait in the regular queue of the agent to get attention, as some such issues need to be addressed as soon as possible solely due to the nature of the issue, e.g., medical emergency, fraud, service shutdown/loss, or other similar types of issues considered higher priority by a particular type of business (e.g., medical, financial, computer service, etc.).

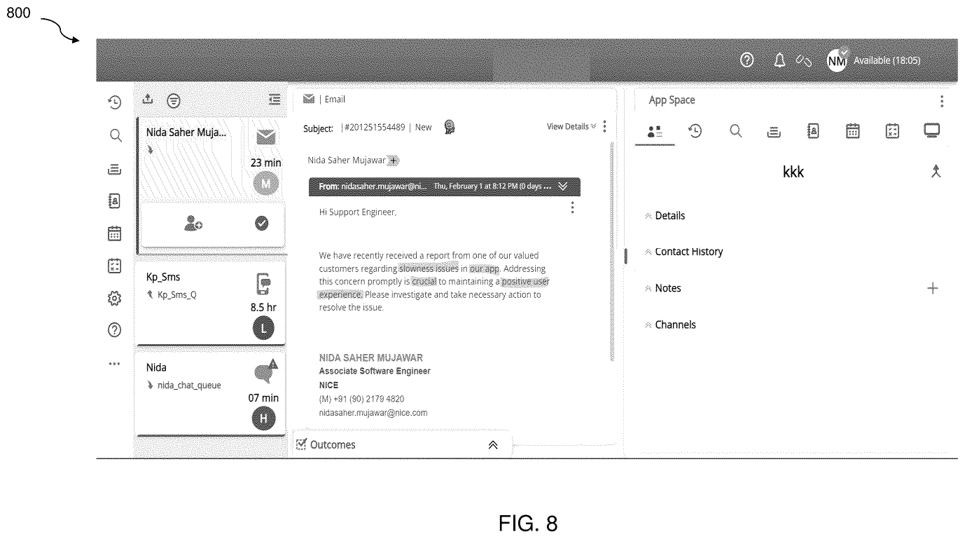

FIG. 8 illustrates a second example simulation 800. The highlighted key phrases “slowness issue,” “app,” and “positive user experience” are extracted from the customer message by using match logic against the customized historical database.

The historical relevance score is based on key phrases like application slowness that is retrieved from the customized historical database. The key phrase relevance score is based on the key phrases like slowness issue, app, and positive user experience from the message. The context relevance score is based on the type of customer such as a premium/high-value customer.

With the current example, the below values are provided:

$$H = 30 , EKP = 20 , C = 10$$

$$PS = 1 - ( 30 + 20 + 10 / 100 ) = 0.4$$

The interaction is flagged as medium priority by applying a yellow visual indicator to it due to the keywords of the interaction falling into a category of an interaction that does not need immediate attention from the contact center agent as compared to the first simulation example. Such customer issues should be given attention, but they can wait for some time since customer is not completely blocked. This cannot be considered low priority because the customer can get frustrated due to the keywords mentioned in the text.

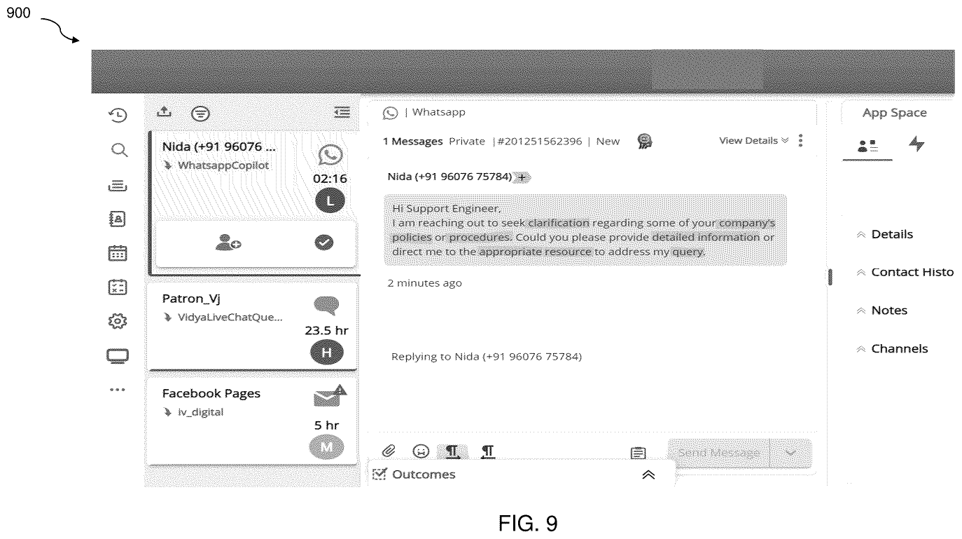

FIG. 9 illustrates a third simulation example 900. The highlighted key phrases “clarification,” “company's policies,” “procedures,” “appropriate resource,” and “query” are extracted from the customer's message using match logic against the customized historical database.

The historical relevance score is based on key phrases like clarification, company's policies, and procedures that are retrieved from the customized historical database. The key phrase relevance score is based on the key phrases like clarification, company's policies, procedures, appropriate resource, and query from the message. The context relevance score is based on the type of customer such as a premium/high-value customer.

With the current example, the below values are provided:

$$H = 45 , EKP = 25 , C = 5$$

$$PS = 1 - ( 45 + 25 + 5 / 100 ) = 0.25$$

The interaction is flagged as low priority by applying a green visual indicator to it due to the keywords of the interaction falling into a category of an interaction that looks like a request about some information. Since these customer interactions are related to basic queries, it does not go into the zone where it could escalate on the contact center platform within minutes or hours.

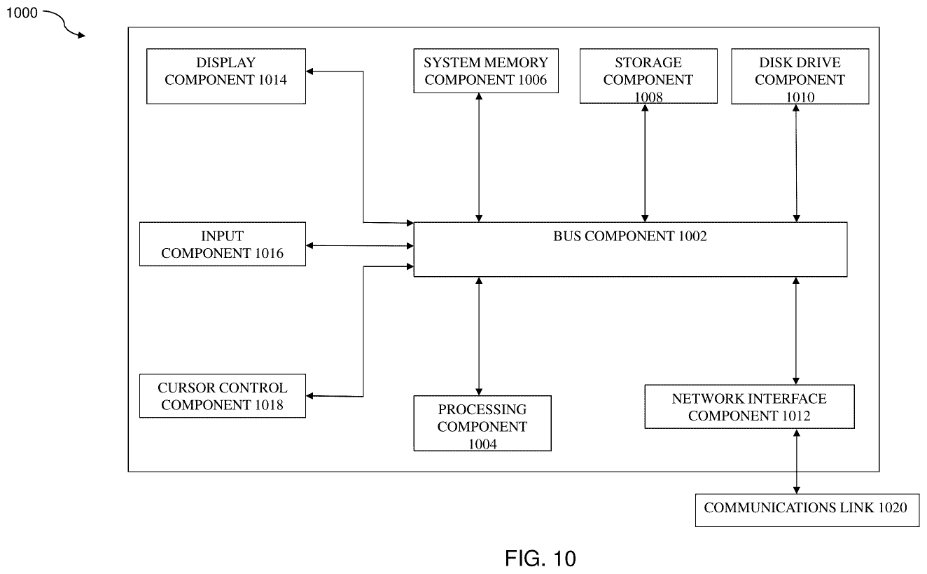

Referring now to FIG. 10, illustrated is a block diagram of a system 1000 suitable for implementing embodiments of the present disclosure. System 1000, such as part of a computer and/or a network server, includes a bus 1002 or other communication mechanism for communicating information, which interconnects subsystems and components, including one or more of a processing component 1004 (e.g., processor, micro-controller, digital signal processor (DSP), etc.), a system memory component 1006 (e.g., RAM), a static storage component 1008 (e.g., ROM), a network interface component 1012, a display component 1014 (or alternatively, an interface to an external display), an input component 1016 (e.g., keypad or keyboard), and a cursor control component 1018 (e.g., a mouse pad).

In accordance with embodiments of the present disclosure, system 1000 performs specific operations by processor 1004 executing one or more sequences of one or more instructions contained in system memory component 1006. Such instructions may be read into system memory component 1006 from another computer readable medium, such as static storage component 1008. These may include instructions to receive a transcript of a first customer interaction in an agent inbox; extract, in real-time, keywords from the transcript; compare, in real-time by an artificial intelligence (AI) model, the extracted keywords to keywords in a customized historical database; calculate, in real-time by the AI model, a priority score of the first customer interaction based on the comparison; assign, in real-time by the AI model, a priority to the first customer interaction based on the calculated priority score; and apply, in real-time, a visual indicator on the first customer interaction in the agent inbox, wherein the visual indicator corresponds to the assigned priority of the first customer interaction. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1004 for execution. The medium may take many forms, including but not limited to, non-volatile media, volatile media, and transmission media. In various implementations, volatile media includes dynamic memory, such as system memory component 1006, and transmission media includes coaxial cables, copper wire, and fiber optics, including wires that comprise bus 1002. Memory may be used to store visual representations of the different options for searching or auto-synchronizing. In one example, transmission media be acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1000. In various other embodiments, a plurality of systems 1000 coupled by communication link 1020 (e.g., LAN, WLAN, PTSN, or various other wired or wireless networks) may perform instruction sequences to practice the disclosure in coordination with one another. Computer system 1000 may transmit and receive messages, data, information and instructions, including one or more programs (i.e., application code) through communication link 1020 and communication interface 1012. Received program code may be executed by processor 1004 as received and/or stored in disk drive component 1010 or some other non-volatile storage component for execution.

The Abstract at the end of this disclosure is provided to comply with 37 C.F.R. § 1.72 (b) to allow a quick determination of the nature of the technical disclosure. It is submitted with the understanding that it will not be used to interpret or limit the scope or meaning of the claims.

What is claimed is:

1. An interaction prioritization system comprising:
a processor and a non-transitory computer readable medium operably coupled thereto, the non-transitory computer readable medium comprising a plurality of instructions stored in association therewith that are accessible to, and executable by, the processor, to perform operations which comprise:
receiving a transcript of a first customer interaction in an agent inbox;
extracting, in real-time, keywords from the transcript;
comparing, in real-time by an artificial intelligence (AI) model, the extracted keywords to keywords in a customized historical database;
calculating, in real-time by the AI model, a priority score of the first customer interaction based on the comparison;
assigning, in real-time by the AI model, a priority to the first customer interaction based on the calculated priority score; and
applying, in real-time, a visual indicator on the first customer interaction in the agent inbox, wherein the visual indicator corresponds to the assigned priority of the first customer interaction.

2. The interaction prioritization system of claim 1, wherein the assigned priority of the first customer interaction is low, medium, or high and the visual indicator is colored based on the assigned priority.

3. The interaction prioritization system of claim 1, wherein the visual indicator is colored and a green visual indicator is applied to a low priority customer interaction, a yellow visual indicator is applied to a medium priority customer interaction, and a red visual indicator is applied to a high priority customer interaction.

4. The interaction prioritization system of claim 1, wherein the keywords in the customized historical database are categorized as low priority, medium priority, or high priority.

5. The interaction prioritization system of claim 1, wherein the customized historical database further comprises historical attributes of interactions that are categorized as low priority medium priority, or high priority.

6. The interaction prioritization system of claim 5, wherein the operations further comprise comparing attributes of the first customer interaction to the historical attributes in the customized historical database, wherein the priority score of the first customer interaction is further based on the comparison of the attributes to the historical attributes.

7. The interaction prioritization system of claim 1, wherein the operations further comprise:
receiving a transcript of a second customer interaction in the agent inbox;
extracting, in real-time, keywords from the transcript of the second customer interaction;
comparing, in real-time, the extracted keywords from the transcript of the second customer interaction to the keywords in the customized historical database;
calculating, in real-time, a priority score of the second customer interaction based on the comparison;
assigning, in real-time, a priority to the second customer interaction based on the calculated priority score;
applying, in real-time, the visual indicator on the second customer interaction in the agent inbox, wherein the visual indicator corresponds to the assigned priority of the second customer interaction; and
sorting the first customer interaction and the second customer interaction in the agent inbox based on the assigned priority, wherein a customer interaction with a higher assigned priority is placed closer to a top of the agent inbox than a customer interaction with a lower assigned priority.

8. The interaction prioritization system of claim 1, wherein calculating the priority score of the first customer interaction comprises determining a historical relevance score, a key phrase relevance score, and a context relevance score.

9. The interaction prioritization system of claim 8, wherein:
determining the historical relevance score comprises comparing the extracted keywords to the keywords in the customized historical database;
determining the key phrase relevance score comprises scoring the extracted keywords based on relevance and importance of the extracted keywords in the transcript; and
determining the context relevance score comprises extracting an urgency associated with the first customer interaction, a sentiment associated with the first customer interaction, a customer type of a customer associated with the first customer interaction, or a combination thereof.

10. A method for prioritizing customer interactions, which comprises:
receiving a transcript of a first customer interaction in an agent inbox;
extracting, in real-time, keywords from the transcript;
comparing, in real-time by an artificial intelligence (AI) model, the extracted keywords to keywords in a customized historical database;
calculating, in real-time by the AI model, a priority score of the first customer interaction based on the comparison;
assigning, in real-time by the AI model, a priority to the first customer interaction based on the calculated priority score; and
applying, in real-time, a visual indicator on the first customer interaction in the agent inbox, wherein the visual indicator corresponds to the assigned priority of the first customer interaction.

11. The method of claim 10, wherein the keywords in the customized historical database are categorized as low priority, medium priority, or high priority.

12. The method of claim 10, wherein the customized historical database further comprises historical attributes of interactions that are categorized as low priority, medium priority, or high priority.

13. The method of claim 12, which further comprises comparing attributes of the first customer interaction to the historical attributes in the customized historical database, wherein the priority score of the first customer interaction is further based on the comparison of the attributes to the historical attributes.

14. The method of claim 10, which further comprises:
receiving a transcript of a second customer interaction in the agent inbox;
extracting, in real-time, keywords from the transcript of the second customer interaction;
comparing, in real-time, the extracted keywords from the transcript of the second customer interaction to the keywords in the customized historical database;
calculating, in real-time, a priority score of the second customer interaction based on the comparison;
assigning, in real-time, a priority to the second customer interaction based on the calculated priority score;
applying, in real-time, a visual indicator on the second customer interaction in the agent inbox, wherein the visual indicator corresponds to the assigned priority of the second customer interaction; and
sorting the first customer interaction and the second customer interaction in the agent inbox based on the assigned priority, wherein a customer interaction with a higher assigned priority is placed closer to a top of the agent inbox than a customer interaction with a lower assigned priority.

15. The method of claim 10, wherein:
calculating the priority score of the first customer interaction comprises determining a historical relevance score, a key phrase relevance score, and a context relevance score,
determining the historical relevance score comprises comparing the extracted keywords to the keywords in the customized historical database,
determining the key phrase relevance score comprises scoring the extracted keywords based on relevance and importance of the extracted keywords in the transcript, and
determining the context relevance score comprises extracting an urgency associated with the first customer interaction, a sentiment associated with the first customer interaction, a customer type of a customer associated with the first customer interaction, or a combination thereof.

16. A non-transitory computer-readable medium having stored thereon computer-readable instructions executable by a processor to perform operations which comprise:
receiving a transcript of a first customer interaction in an agent inbox;
extracting, in real-time, keywords from the transcript;
comparing, in real-time by an artificial intelligence (AI) model, the extracted keywords to keywords in a customized historical database;
calculating, in real-time by the AI model, a priority score of the first customer interaction based on the comparison;
assigning, in real-time by the AI model, a priority to the first customer interaction based on the calculated priority score; and
applying, in real-time, a visual indicator on the first customer interaction in the agent inbox, wherein the visual indicator corresponds to the assigned priority of the first customer interaction.

17. The non-transitory computer-readable medium of claim 16, wherein the customized historical database further comprises historical attributes of interactions that are categorized as low priority, medium priority, or high priority.

18. The non-transitory computer-readable medium of claim 17, wherein the operations further comprise comparing attributes of the first customer interaction to the historical attributes in the customized historical database, wherein the priority score of the first customer interaction is further based on the comparison of the attributes to the historical attributes.

19. The non-transitory computer-readable medium of claim 16, wherein the operations further comprise:
receiving a transcript of a second customer interaction in the agent inbox;
extracting, in real-time, keywords from the transcript of the second customer interaction;
comparing, in real-time, the extracted keywords from the transcript of the second customer interaction to the keywords in the customized historical database;
calculating, in real-time, a priority score of the second customer interaction based on the comparison;
assigning, in real-time, a priority to the second customer interaction based on the calculated priority score;
applying, in real-time, a visual indicator on the second customer interaction in the agent inbox, wherein the visual indicator corresponds to the assigned priority of the second customer interaction; and
sorting the first customer interaction and the second customer interaction in the agent inbox based on the assigned priority, wherein a customer interaction with a higher assigned priority is placed closer to a top of the agent inbox than a customer interaction with a lower assigned priority.

20. The non-transitory computer-readable medium of claim 16, wherein:
calculating the priority score of the first customer interaction comprises determining a historical relevance score, a key phrase relevance score, and a context relevance score,
determining the historical relevance score comprises comparing the extracted keywords to the keywords in the customized historical database,
determining the key phrase relevance score comprises scoring the extracted keywords based on relevance and importance of the extracted keywords in the transcript, and
determining the context relevance score comprises extracting an urgency associated with the first customer interaction, a sentiment associated with the first customer interaction, a customer type of a customer associated with the first customer interaction, or a combination thereof.
